(19) United States
(12) Patent Application Publication
(10) Pub. No.: US 2025/0361449 A1
(43) Pub. Date: Nov. 27, 2025

(54) PARTICULATE REMOVAL SYSTEM FOR USE IN HYDROPROCESSING

(71) Applicant: SHELL USA, INC., Houston, TX (US)

(72) Inventors: Zhong Xin CHEN, Beijing (CN); Steffen JANCKER, Hamburg (DE); Ramkumar RAMANATHAN, Bangalore North (IN)

(21) Appl. No.: 18/873,770

(22) PCT Filed: Jun. 23, 2023
(86) PCT No.: PCT/US2023/068924

§ 371 Date: Dec. 11, 2024

Related U.S. Application Data
(60) Provisional application No. 63/354,885, filed on Jun. 23, 2022.

(51) Int. Cl. C10G 1/06; B01D 46/24; B01D 46/70; C10B 53/02; C10B 53/07; C10B 57/06

(52) U.S. Cl. CPC C10G 1/06; B01D 46/2407; B01D 46/70; C10B 53/02; C10B 53/07; C10B 57/06; B01D 2273/20; C10G 2300/1003; C10G 2300/1011

(57) ABSTRACT

A process for producing liquid hydrocarbon products from a solid feedstock includes feeding the solid feedstock and hydrogen to a first stage hydropyrolysis reactor having one or more deoxygenation catalyst, and the solid feedstock includes biomass, waste plastic, or a combination thereof. The process also includes hydropyrolysing the solid feedstock in the first stage hydropyrolysis reactor to generate a process gas stream having partially deoxygenated hydropyrolysis product, H₂O, H₂, CO₂, CO, C₁-C₃ gases, and char and catalyst fines and feeding the process gas stream to a solid separation system having a hot gas filtration unit having a plurality of filter elements that may separate the char and catalyst fines from the process gas to generate a vapour phase product and a dust filter cake.

The present disclosure generally relates to systems and methods for removal of particulates. More specifically, the present disclosure relates to a solid removal system integrated into a hydroprocessing system.

### BACKGROUND OF THE DISCLOSURE

The demand for energy is increasing as a result of worldwide economic growth and development. This increase in the demand for energy has contributed to an increase in the amount of greenhouse gases and the overall carbon footprint. In addition, with increasing demand for liquid transportation fuels, decreasing reserves of crude petroleum oil that may be accessed and recovered easily and increasing constraints on carbon footprints of such fuels, it may be desirable to develop routes to produce liquid transportation fuels from renewable resources in an efficient manner. Such liquid transportation fuels produced from biomass are sometimes also referred to as biofuels. Biomass offers a source of renewable carbon. Examples of suitable biomass include vegetable oils, oils obtained from algae and animal fats, deconstruction materials such as pyrolyzed recyclable materials and wood, straws, forestry residues, among others. Therefore, when using fuels derived from renewable resources, it may be possible to achieve more sustainable CO2 emissions over petroleum-derived fuels. For biofuels to replace all or at least a portion of the carbon-based fossil fuels, the biofuels should meet the required performance and emission specifications of the carbon-based fossil fuels.

Currently, systems used for removing particulates (e.g., biochar, ash, catalyst fines) from a product gas stream generated in a hydroprocessing reactor include cyclones. For example, existing systems may include one or multiple consecutive cyclones that receive the product gas stream and remove the particulates entrained in the product gas stream. However, the efficiency of the cyclones to remove the entrained particulates from the product gas stream is in the range of approximately 99.95%, which is undesirable. Therefore, hydroprocessing systems that use cyclones alone to remove the entrained particulates also include guard beds downstream of the solid removal system that capture and remove the particulates that were not removed by the cyclones. The addition of the guard bed downstream of the solid removal system increases the overall cost of the hydroprocessing system. Additionally, while multiple cyclones may be used in series or in combination with a third stage separator, this increases the complexity and overall cost of hydroprocessing systems due to the additional equipment, maintenance, and space required for installation. Accordingly, it would be advantageous to provide a solid removal system having an improved particulate removal efficiency that may be integrated into hydroprocessing systems without the use of a guard bed or other solid removal systems.

### SUMMARY

In an embodiment, a process for producing liquid hydrocarbon products from a solid feedstock includes feeding the solid feedstock and hydrogen to a first stage hydropyrolysis reactor. The first stage hydropyrolysis reactor has one or more deoxygenation catalyst, and the solid feedstock includes biomass, waste plastic, or a combination thereof. The process also includes hydropyrolysing the solid feedstock in the first stage hydropyrolysis reactor to generate a process gas stream having partially deoxygenated hydropyrolysis product, H₂O, H₂, CO₂, CO, C₁-C₃ gases, and char and catalyst fines and feeding the process gas stream to a solid separation system having a hot gas filtration unit having a plurality of filter elements that may separate the char and catalyst fines from the process gas to generate a vapour phase product and a dust filter cake. The vapour phase product includes the partially deoxygenated hydropyrolysis product, H₂O, H₂, CO₂, CO, and C₁-C₃ gases, and the dust filter cake is disposed on an outer surface of the plurality of filter elements and includes the char and catalyst fines.

In another embodiment, a system for producing liquid hydrocarbon products from a solid feedstock includes a hydropyrolysis reactor having one or more deoxygenation catalyst and that may generate a process gas stream having partially deoxygenated hydropyrolysis product, H₂O, H₂, CO₂, CO, C₁-C₃ gases, and char and catalyst fines. The solid feedstock includes biomass, waste plastic, or a combination thereof. The system also includes a solid separation system disposed downstream from and fluidly coupled to the hydropyrolysis reactor. The solid separation system may receive the process gas stream and includes a hot gas filtration unit having a plurality of filter elements that may remove the char and catalyst fines from the process gas stream to generate a vapour phase product having the partially deoxygenated hydropyrolysis product, H₂O, H₂, CO₂, CO, and C₁-C₃ gases. The system further includes a hydroconversion reactor disposed downstream from and fluidly coupled to the solid separation system and including one or more hydroconversion catalyst. The hydroconversion reactor may receive the vapour phase product from the solid separation system and to generate a hydrocarbon product from the vapour phase product. The hydrocarbon product includes substantially fully deoxygenated hydrocarbon product, H₂O, CO, CO₂, and C₁-C₃ gases.

In a further embodiment, a process for producing liquid hydrocarbon products from a solid feedstock includes hydropyrolysing the solid feedstock in a hydropyrolysis reactor to generate a process gas stream having partially deoxygenated hydropyrolysis product, H₂O, H₂, CO₂, CO, C₁-C₃ gases, and char and catalyst fines and feeding the process gas stream to a solid separation system disposed downstream from and fluidly coupled to the hydropyrolysis reactor. The solid separation system includes a hot gas filtration unit having a plurality of filter elements each including a conduit having a plurality of pores. The process also includes filtering the process gas stream through the respective conduit of the plurality of filter elements to separate the char and catalyst fines from the process gas and to generate a vapour phase product and a dust filter cake. The vapour phase product includes the partially deoxygenated hydropyrolysis product, H₂O, H₂, CO₂, CO, and C₁-C₃ gases, the dust filter cake is disposed on an outer surface of the respective conduit of the plurality of filter elements, and the dust filter cake includes the char and catalyst fines.

Additional features and advantages of exemplary implementations of the disclosure will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

Advantages of the disclosure may become apparent upon reading the following detailed description and upon reference to the drawings in which:

FIG. 1 is a block diagram of a hydroprocessing system having a first stage and a second stage used to produce hydrocarbons from biomass, whereby the system includes a solid separation system having a hot gas filtration unit, in accordance with an embodiment of the present disclosure;

FIG. 2 is a diagram of the solid separation system of FIG. 1, whereby the hot gas filtration unit includes one or more candle filters and the solid separation system includes solids vessels downstream of the hot gas filtration unit arranged in series, in accordance with an embodiment of the present disclosure;

FIG. 3 is a diagram of the solid separation system of FIG. 1, whereby the hot gas filtration unit includes one or more candle filters and the solid separation system includes solids vessels downstream of the hot gas filtration unit arranged in series and parallel, in accordance with an embodiment of the present disclosure;

FIG. 4 is a flow diagram of a method for removing entrained solids from a process gas stream using the solid separation system of FIG. 1, in accordance with an embodiment of the present disclosure; and

FIG. 5 is a schematic of the hot gas filtration unit of FIGS. 1-3, in accordance with an embodiment of the present disclosure.

### DETAILED DESCRIPTION

One or more specific embodiments of the present disclosure will be described below. These described embodiments are examples of the presently disclosed techniques. Additionally, in an effort to provide a concise description of these embodiments, not all features of an actual implementation may be described in the specification. It should be appreciated that in the development of any such actual implementation, as in any engineering or design project, numerous implementation-specific decisions will be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The terms “approximately,” “about,” and “substantially” as used herein represent an amount close to the stated amount that still performs a desired function or achieves a desired result. For example, the terms “approximately,” “about,” and “substantially” may refer to an amount that is within less than 10% of, within less than 5% of, within less than 1% of, within less than 0.1% of, and within less than 0.01% of a stated amount.

The disclosed embodiments include a solid separation system having a hot gas filtration unit that may be used to remove entrained solids/particulates from a process gas generated in a hydroprocessing reactor (e.g., a hydropyrolysis reactor). Hydroprocessing is a catalytic process that includes hydropyrolysis, hydroconversion, and/or hydrotreating of certain carbon-containing materials to generate hydrocarbon fuels. During hydropyrolysis, the carbon-containing materials (e.g., biomass, waste plastic, and other solid feedstock from renewable resources) undergoes partial deoxygenation in the presence of hydrogen under hydropyrolysis conditions. The hydropyrolysis of the solid feedstock generates a process gas having partially deoxygenated hydrocarbons and solids such as char and fines (e.g., ash, catalyst fines, etc.). The solids may be entrained in the process gas when it exists the hydropyrolysis reactor and are removed in a solid separation system downstream of the hydropyrolysis reactor. Existing solid separation systems used in hydroprocessing systems include cyclones that separate the entrained solids from the process gas. However, the separation efficiency of cyclones is such that an undesirable portion of the entrained solids remain in the process gas after passing through the cyclone. For example, cyclones generally remove approximately 99.95% or less of the entrained solids. Even when multiple cyclones are used (e.g., in series), an undesirable amount of solids still remain entrained in the process gas downstream of the solid separation systems. The entrained solids remaining in the process gas may lead to plugging and/or fouling of downstream equipment and impacts the overall efficiency of hydroprocessing. As such, to mitigate plugging and/or fouling of downstream equipment, a guard bed is positioned downstream of the solid separation system to removes entrained solids remaining in the process gas. The undesirable solid separation efficiency of the cyclones and the addition of the guard bed increase the overall cost and complexity of the hydroprocessing system. Accordingly, it is desirable to develop a solid separation system having an improved separation efficiency and decreased overall operational cost compared to existing systems that use cyclones for solid separation.

As discussed in further detail below, the use of hot gas filters (e.g., candle filters) to removed entrained solids from process gas generated in a hydropyrolysis reactor improves the separation efficiency of the solid separation system and also decreases the overall operational cost of hydroprocessing compared to existing systems. For example, the use of hot gas filters may improve the separation efficiency of the solid separation system disclosed herein to greater than 99.99% compared to 99.95% for cyclones. An improvement in the separation efficiency of approximately 0.04% or more results in a desirable decrease in the overall cost of operating the hydroprocessing system compared to systems that use cyclones for separating entrained solids. In addition, by using hot gas filtration in the solid separation system disclosed herein, the guard bed generally used in existing systems downstream of the solid separation system may be omitted. However, while hot gas filtration may result in a desirable improvement in the removal efficiency of the solid separation system, the process gas generated in the hydropyrolysis reactor does not undergo complete combustion and, therefore, contains oxygenates and other reactive species that may continue to react while in the solid separation system. For example, the oxygenates and/or reactive species in the process gas may form condensates and tar, thereby plugging pores of the hot gas filters. However, as disclosed herein, by controlling a temperature of the process gas in combination with the use of a blow back gas through the hot gas filters, formation of condensates and tar may be mitigated. As such, hot gas filters may be integrated into the hydroprocessing system and used to remove entrained solids from the process gas generated in the hydropyrolysis reactor, thereby improving the separation efficiency of the solid separation system and decreasing the overall operational costs of hydroprocessing systems compared to those systems that use cyclones in the solid separation system.

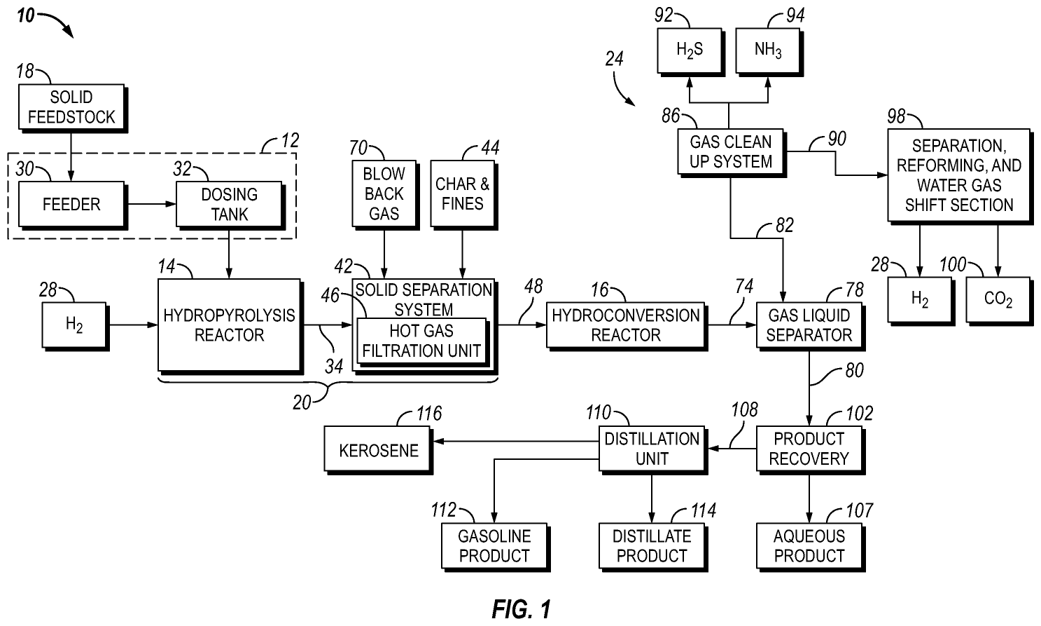

With the foregoing in mind, FIG. 1 is a block diagram of an embodiment of a system 10 that includes the disclosed hot gas filter(s) in a solid separation system for providing a process gas that is essentially free of entrained solids. As used herein, the phrase “essentially free of entrained solids” is intended to denote less than or equal to 0.009% (or less than 1 milligram (mg)/normal cubic meters (Nm³)) entrained solids. As should be appreciated, the process gas and other hydroprocessing products disclosed herein may be generated by any suitable hydroprocessing technique such as those disclosed in U.S. Pat. No. 9,447,328, which is hereby incorporated by reference in its entirety. In the illustrated embodiment, the system 10 includes a solid feedstock feeding system 12, a hydropyrolysis reactor 14 positioned downstream from and fluidly coupled to the solid feedstock feeding system 12, and a hydroconversion reactor 16 positioned downstream from and fluidly coupled to the hydropyrolysis reactor 14. As discussed in further detail below, the reactors 14, 16 are used to convert a solid feedstock 18 into an intermediate hydrocarbon fuel fraction (e.g., a GO/diesel fraction) that may be used to generate a commercially viable biodiesel. As illustrated, the reactors 14, 16 are disposed within one of two stages. For example, the system 10 includes a first stage 20 and a second stage 24. The first stage 20 includes the hydropyrolysis reactor 14, and the second stage 24 includes the hydroconversion reactor 16. The reaction pressure in the first stage 20 and the second stage 22 may be varied to tailor the boiling point distribution and composition of the resultant hydrocarbon product(s) generated by the second stage 24. The ability to tailor the boiling point distribution and/or composition of the resultant hydrocarbon product by varying the reaction pressure may provide an efficient process for generating commercially viable hydrocarbon biofuels that meet the different requirements set forth by the location and/or market in which the hydrocarbon biofuel will be used. For example, when the reaction pressure is less than approximately 0.6 megapascals (MPa) the occurrence of undesirable olefin and/or aromatic saturation reactions may be decreased and cetane numbers for biodiesel and/or gasoline fractions may be increased compared to reaction pressures above 2.0 MPa. However, the cetane numbers may still not be at a desired level to meet specifications set forth for commercial biodiesel fuels. Therefore, the biodiesel fraction may need to undergo additional processing (e.g., hydropolishing) to upgrade the biodiesel and increase the cetane number above approximately 50. Therefore, in certain embodiments, the hydroprocessing system may include a third stage downstream of the second stage 24 where one or more the biodiesel fraction(s) undergo additional processing.

### First Stage

In the illustrated embodiment, the solid feedstock 18 having biomass (e.g., lignocellulose) and/or waste plastics and molecular hydrogen (H₂) 28 are introduced into the hydropyrolysis reactor 14. For example, the solid feedstock 18 is fed to a feeder 30 of the solid feedstock feeding system 12. The feeder 30 may be any feeder suitable for feeding solids such as a screw conveyor, piston feeder, or the like. The solid feedstock feeding system 12 also includes a dosing tank 32 downstream from and fluidly coupled to the feeder 30 and the hydropyrolysis reactor 14. In certain embodiments, the solid feedstock feeding system 12 does not include the dosing tank 32. While in the illustrated embodiment, the system 10 has a single hydropyrolysis reactor 14, it should be appreciated that the system 10 may have multiple hydropyrolysis reactors 14. In embodiments, in which the system 10 includes multiple hydropyrolysis reactors 14, the solid feedstock feeding system 12 is fluidly coupled to and provides the solid feedstock 18 to each of the reactors 14.

The hydropyrolysis reactor 14 contains a deoxygenation catalyst that facilitates partial deoxygenation of the solid feedstock 18. For example, in the hydropyrolysis reactor 14, the solid feedstock 18 undergoes hydropyrolysis, producing a process gas 34 having char, partially deoxygenated products of hydropyrolysis, light gases (C₁-C₃ gases, carbon monoxide (CO), carbon dioxide (CO₂), and H₂), water (H₂O) vapor and catalyst fines. As discussed above, the partially deoxygenated products of hydropyrolysis are not fully converted and may continue to react with other components in the process gas 34 to form condensates and tars, which may accumulate on surface of equipment downstream of the hydropyrolysis reactor 14. As discussed in further detail below, controlling the temperature of the process gas 34 such that it is above a condensation temperature mitigates formation of the condensates and tars which facilitates separation of entrained solids (e.g., catalyst fines, char, ash) in the process gas 34.

The hydropyrolysis reactor 14 may be a fluidized bed reactor (e.g., a fluidized bubbling bed reactor), fixed-bed reactor, or any other suitable reactor. In embodiments in which the hydropyrolysis reactor 14 is a fluidized bed reactor, the fluidization velocity, catalyst particle size and bulk density, and solid feedstock particle size and bulk density are selected such that the deoxygenation catalyst remains in the bubbling fluidized bed, while the char produced is entrained with the partially deoxygenated products (e.g., the process gas 34) exiting the hydropyrolysis reactor 14. As should be appreciated, while the majority of the deoxygenation catalyst remains in the bubbling fluidized bed, attrition of the catalyst particles may occur over time and generate catalyst fines. The catalyst fines may become entrained in the process gas 34 along with the char and other fine solids (e.g., ash). The hydropyrolysis step in the first stage 20 employs a rapid heat up of the solid feedstock 18 such that a residence time of the pyrolysis vapors in the hydropyrolysis reactor 14 is preferably less than approximately 1 minute, more preferably less than approximately 30 seconds and most preferably less than approximately 10 seconds.

The solid feedstock 18 used in the disclosed process may include a residual waste feedstock and/or a biomass feedstock containing lignin, lignocellulosic, cellulosic, hemicellulosic material, or any combination thereof. Lignocellulosic material may include a mixture of lignin, cellulose and hemicelluloses in any proportion and also contains ash and moisture. Such material is more difficult to convert into fungible liquid hydrocarbon products than cellulosic and hemicellulosic material. It is an advantage of the present process that it can be used for lignocellulose-containing biomass. Suitable lignocellulose-containing biomass includes woody biomass and agricultural and forestry products and residues (whole harvest energy crops, round wood, forest slash, bamboo, sawdust, bagasse, sugarcane tops and trash, cotton stalks, corn stover, corn cobs, castor stalks, Jatropha whole harvest, Jatropha trimmings, de-oiled cakes of palm, castor and Jatropha, coconut shells, residues derived from edible nut, rice husk, rice straw production and mixtures thereof), animal waste and municipal solid wastes containing lignocellulosic material. The municipal solid waste (MSW) may include any combination of lignocellulosic material (yard trimmings, pressure-treated wood such as fence posts, plywood), discarded paper and cardboard and waste plastics, along with refractories such as glass, metal. Prior to use in the process disclosed herein, municipal solid waste may be optionally converted into pellet or briquette form. The pellets or briquettes are commonly referred to as Refuse Derived Fuel in the industry. Certain feedstocks (such as algae and lemna) may also contain protein and lipids in addition to lignocellulose. Residual waste feedstocks are those having mainly waste plastics. In certain embodiments, the solid feedstock 18 may be different ranks of coal, peat or any other suitable solid feedstock that may be fed to a pressurized reactor.

The solid feedstock 18 may be provided to the hydropyrolysis reactor 14 in the form of loose biomass particles having a majority of particles preferably less than about 3.5 millimeters (mm) in size or in the form of a biomass/liquid slurry. However, as appreciated by those skilled in the art, the solid feedstock 18 may be pre-treated or otherwise processed in a manner such that larger particle sizes may be accommodated. Suitable means for introducing the solid feedstock 18 into the hydropyrolysis reactor 14 include, but are not limited to, an auger, fast-moving (greater than about 5 minutes (m)/second (sec)) stream of carrier gas (such as inert gases and H₂), and constant-displacement pumps, impellers, turbine pumps or the like. In an embodiment of the present disclosure, the solid feedstock feeding system 12 includes a double-screw system having a slow screw for metering the solid feedstock 18 followed by a fast screw to push the solid feedstock 18 into the reactor without causing torrefaction in the screw housing is used for dosing. An inert gas or hydrogen flow is maintained over the fast screw to further reduce the residence time of the solid feedstock 18 in the fast screw housing.

The hydropyrolysis step is carried out in the hydropyrolysis reactor 14 at a temperature in the range of from approximately 300 Celsius (° C.) and 650° C., preferably in the range of from approximately 330° C. to approximately 500° C., more preferably in the range of from approximately 350° C. to approximately 480° C., and a pressure in the range of from approximately 0.50 megapascal (MPa) to approximately 7.5 MPa (approximately 5-75 bar). The heating rate of the solid feedstock 18 is preferably greater than about 100 watts/meter² (W/m²). The weight hourly space velocity (WHSV) in grams (g) biomass/g catalyst/hour (h) for the hydropyrolysis step is in the range of from approximately 0.2 h⁻¹ to approximately 10 h⁻¹, preferably in the range of from approximately 0.3 h⁻¹ to 3 h⁻¹.

The temperatures used in hydropyrolysis rapidly devolatilize the solid feedstock 18. Thus, in a preferred embodiment, the hydropyrolysis step includes the use of an active catalyst (e.g., a deoxygenation catalyst) to stabilize the hydropyrolysis vapors. The activity of the catalyst used herein remains high and stable over a long period of time such that it does not rapidly coke. Catalyst particle sizes, for use in the hydropyrolysis reactor 14, are preferably in the range of from approximately 0.3 millimeter (mm) to approximately 4.0 mm, more preferably in the range of from approximately 0.6 mm to approximately 3.0 mm, and most preferably in the range of from approximately 1 mm to approximately 2.4 mm.

Any deoxygenation catalyst suitable for use in the temperature range of the hydropyrolysis process may be used. Preferably, the deoxygenation catalyst is selected from sulfided catalysts having one or more metals from the group consisting of nickel (Ni), cobalt (Co), molybdenum (Mo) or tungsten (W) supported on a metal oxide. Suitable metal combinations include sulfided NiMo, sulfided CoMo, sulfided NiW, sulfided CoW and sulfided ternary metal systems having any 3 metals from the family consisting of Ni, Co, Mo and W. Monometallic catalysts such as sulfided Mo, sulfided Ni and sulfided W are also suitable for use. Metal combinations for the deoxygenation catalyst used in accordance with certain embodiments of the present disclosure include sulfided NiMo and sulfided CoMo. Supports for the sulfided metal catalysts include metal oxides such as, but not limited to, alumina, silica, titania, ceria and zirconia. Binary oxides such as silica-alumina, silica-titania and ceria-zirconia may also be used. Preferably, the supports include alumina, silica and titania. In certain embodiments, the support contains recycled, regenerated and revitalized fines of spent hydrotreating catalysts (e.g., fines of CoMo on oxidic supports, NiMo on oxidic supports and fines of hydrocracking catalysts containing NiW on a mixture of oxidic carriers and zeolites). Total metal loadings on the deoxygenation catalyst are preferably in the range of from approximately 1.5 weight percent (wt %) to approximately 50 wt % expressed as a weight percentage of calcined deoxygenation catalyst in oxidic form (e.g., weight percentage of Ni (as NiO) and Mo (as MoO₃) on calcined oxidized NiMo on alumina support). Additional elements such as phosphorous (P) may be incorporated into the deoxygenation catalyst to improve the dispersion of the metal.

The first stage 20 of the process disclosed herein produces the process gas 34 having a partially deoxygenated hydropyrolysis product and entrained solids (e.g., char, ash, catalyst fines). The term “partially deoxygenated” as used herein denotes a material in which at least 30 weight % (wt %), preferably at least 50 wt %, more preferably at least 70 wt % of the oxygen present in the original solid feedstock 18 has been removed. The extent of oxygen removal refers to the percentage of the oxygen in the solid feedstock 18 (e.g., biomass), excluding that contained as free moisture in the solid feedstock 18. This oxygen is removed in the form of water (H₂O), carbon monoxide (CO) and carbon dioxide (CO₂) in the hydropyrolysis step. Although it is possible that nearly 100 wt % of the oxygen present in the solid feedstock 18 is removed, generally at most 99 wt %, suitably at most 95 wt % will be removed in the hydropyrolysis step.

### Char Removal

As discussed above, the process gas 34 produced from the hydropyrolysis step in the hydropyrolysis reactor 14 includes a mixed solid and vapor product that includes char, ash, catalyst fines, partially deoxygenated hydropyrolysis product, light gases (C₁-C₃ gases, CO, CO₂, hydrogen sulfide (H₂S), ammonia (NH₃) and H₂), H₂O vapor, vapors of C₄₊ hydrocarbons and oxygenated hydrocarbons. Char, ash, and catalyst fines are entrained with the vapor phase product. Therefore, between the hydropyrolysis and hydroconversion steps, the first stage 20 and the second stage 24, respectively, char and catalyst fines are removed from the vapor phase product (e.g., the partially deoxygenated hydropyrolysis product) in the solid separation system 42. Any ash present may also be removed at this stage.

Generally, the char, ash, and catalyst fines entrained in the process gas 34 are removed via one or more cyclones. However, cyclone separation does not provide the desired separation efficiency. For example, the separation efficiency of cyclones is such that approximately 0.05% solids remain entrained in the process gas after having passed through the cyclone(s). This amount of entrained solids may have an undesirable impact on the overall efficiency of the hydroprocessing process. For example, the remaining entrained solids may plug and/or foul downstream equipment. As such, hydroprocessing systems that utilize cyclones to remove entrained solids also include a guard bed downstream of the cyclones to capture and remove the remaining solids from the process gas. The inefficient separation of solids from the process gas using cyclones and the addition of the guard bed, increase the overall cost of hydroprocessing. Unlike cyclones, hot gas filters (e.g., candle filters) are known to have solid separation efficiencies in excess of 99.99%. The improved separation efficiency of hot gas filters compared to cyclones results in reduced operation and capital costs for hydroprocessing systems. Accordingly, the disclosed solid separation system 12 includes one or more hot gas filtration units 46 that remove the char and other solids in the process gas 34 to generate a vapor phase product 48. For example, as illustrated in FIG. 1, the process gas 34 is fed to a solid separation system 42 in which the hot gas filtration unit 46 separates/removes the solids (e.g., char, ash, and catalyst fines 44) from the process gas 34.

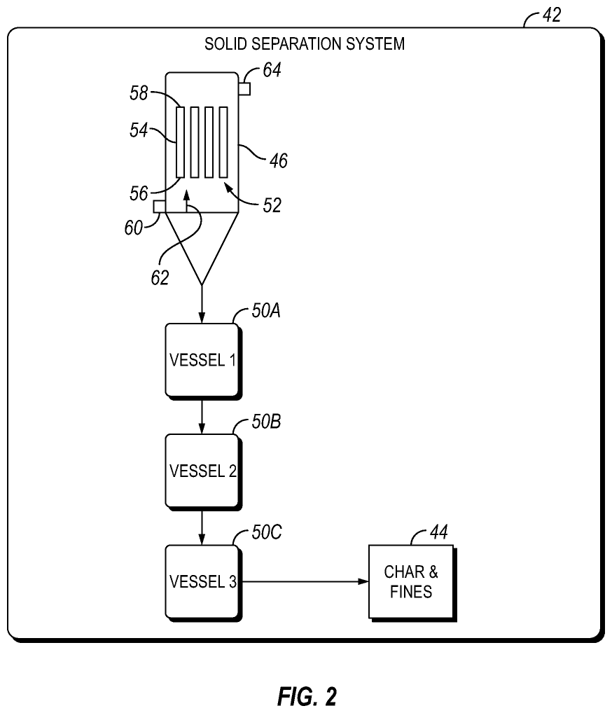

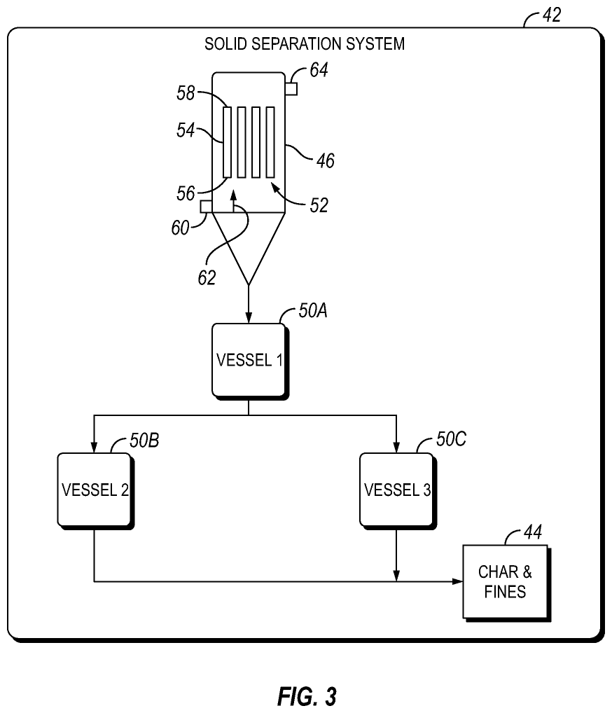

For example, referring to FIGS. 2 and 3, the solid separation system 12 includes the hot gas filtration unit 46 and vessels 50a, 50b, 50c. The vessels 50 may be arranged in series (FIG. 2), in parallel, or a combination of in series and parallel (FIG. 3). While the three vessels 50 are shown in the illustrated embodiments, it should be appreciated that any number of vessels may be used. For example, the solid separation system may have 1, 2, 3, 4, or more vessels 50. The hot gas filtration unit 46 includes a plurality of filter elements 52 (e.g., filter candles) that separate the solids from the vapour phase product 48. The filter elements 52 include cylindrical conduits 54 generally made of porous ceramic or metallic materials having a closed upstream end 56 and an open end 58 on the downstream side. Each conduit 54 may be between 1 and 3 meters (m) in length and have a diameter of approximately 60 and 150 millimeters (mm). The filter elements 52 have a permeability that ranges between 15 and 65×10¹³ square meters (m²) with pore diameters in the range of approximately 5 and 15 microns (μm).

During operation, the process gas 34 flows into the hot gas filtration unit 46 via an inlet 60 and flows in a direction 62 toward the filter elements 52. The process gas 34 flows into the conduits 54 through the pores where the entrained solids in the process gas 34 are unable to pass through the pores and separated from the process gas 34. The separated solids accumulate on an outer surface of the conduits 54, resulting in formation of a dust filter cake. The resultant vapour phase product 48 flows within the conduits 54 toward the open end 58 and is released from the hot gas filtration unit 46 via an outlet 64. The dust cake may be removed from the outer surface of the conduits 54 by back pulsing using a fluid (e.g., hydrogen, carbon dioxide, air, steam, clean process gas, and/or inert gases) and collected in one or more of the vessels 50. For example, returning to FIG. 1, a blow back gas 70 is provided to the hot gas filtration unit 46 (e.g., through the open end 58) of the filter element 52 such that it flows through the conduit 54 toward the closed end and out through the pores to remove the dust filter cake (e.g., the char and fines 44) accumulated on the filter elements 52. The blow back gas 70 may be the hydrogen 28, carbon dioxide (CO₂), air, steam or any other suitable fluid and combinations thereof. Using the hydrogen 28 as the blow back gas 70 may be advantageous as dilution of the hydroprocessing process is avoided. The hydrogen 28 may also stabilize the free radicals and saturated the olefins in the vapour phase product 48. Moreover, by using the hydrogen 28, it may not be necessary to incorporate additional equipment or cleaning process to remove a blow back gas that is not hydrogen.

As discussed above, the process gas 34 includes partially deoxygenated hydropyrolysis product and catalyst fines. The partially deoxygenated hydropyrolysis product may continue to react while in the solid separation system 42 which may lead to coking and formation of tars and condensates. The tars and condensates may collect on and plug the pores of the filter elements (e.g., the filter elements 52). As such, a temperature of the blow back gas 70 is maintained above the condensation temperature of the vapour phase product 48 to avoid coking and formation of condensates and tars. In addition, in certain embodiments, the temperature of the blow back gas 70 is maintained above a desublimation temperature of the salts (e.g., ammonia chloride (NH₄Cl) present in the vapour phase product 48 to mitigate degradation of the hot gas filtration unit 46 and decrease the overall performance of the filter elements 52. For example, if the temperature of the vapour phase product 48 is below the desublimation temperature, corrosive salts may sublime and collect on portions of the hot gas filtration unit 46 and/or the filter elements 52, thereby degrading the material of the hot gas filtration unit 46 and/or filter element 52, blocking flow of the blow back gas 70 through the filter elements 52, and decreasing the overall performance of the hot gas filtration unit 46 for separation of the particulates (e.g., char, ash) from the vapour phase product 48. Therefore, the temperature of the blow back gas 70 may be approximately 10 to 30° C. above the condensation/desublimation temperature of the vapour phase product 48. Accordingly, the temperature of the blow back gas 70 is above approximately 250° C. In particular, between approximately 300 and 450° C., preferably between approximately 350 and 400° C.

### Second Stage

Following removal of the char and catalyst fines 44, the vapor phase product 48 (e.g., the partially deoxygenated hydropyrolysis product) together with the H₂, CO, CO₂, H₂O, and C₁-C₃ gases from the hydropyrolysis step (e.g., the first stage 20) are fed into the hydroconversion reactor 16 in the second stage 24 and subjected to a hydroconversion step. The hydroconversion step is carried out at a temperature in the range of from approximately 300° C. to approximately 600° C. and a pressure in the range of from approximately 0.1 MPa to approximately 5 MPa. As should be noted, pressures higher than 0.6 MPa may be used to tailor the boiling point distribution and composition of the resultant hydrocarbon product based on the desired specifications of the hydrocarbon fuel produced by the hydroprocessing. The weight hourly space velocity (WHSV) for this step is in the range of approximately 0.1 h⁻¹ to approximately 2 h⁻¹. The hydroconversion reactor 16 is a fixed bed reactor. However, in certain embodiments, the hydroconversion reactor 16 may be a fluidized bed reactor. The vapor phase product 48 undergoes hydroconversion in the presence of a hydroconversion catalyst to generate a fully deoxygenated hydrocarbon product 74. The term “fully deoxygenated” as used herein denotes a material in which at least 98 wt %, preferably at least 99 wt %, more preferably at least 99.9 wt % of the oxygen present in the original solid feedstock 18 (e.g., lignocelluloses-containing biomass) has been removed. The hydrocarbon product 74 contains light gaseous hydrocarbons, such as methane, ethane, ethylene, propane and propylene, naphtha range hydrocarbons, middle-distillate range hydrocarbons, hydrocarbons boiling above 370° C. (based on ASTM D86), hydrogen and by-products of the hydroconversion reactions such as H₂O, H₂S, NH₃, CO and CO₂.

The solid feedstock 18 used in the disclosed processes may contain metals such as, but not limited to, sodium (Na), potassium (K), calcium (Ca) and phosphorus (P). These metals may poison the hydroconversion catalyst used in the second stage 24. However, these metals may be removed with the char and ash products (e.g., the char and catalyst fines 44) in the first stage 20. Accordingly, the hydroconversion catalyst used in the hydroconversion step is protected from Na, K, Ca, P, and other metals present in the solid feedstock 18 which may otherwise poison the hydroconversion catalyst. Moreover, by hydropyrolysis of the solid feedstock 18 in the first stage 20, the hydroconversion catalyst is advantageously protected from olefins and free radicals. The conditions under which hydropyrolysis occurs in the first stage 20 stabilize free radicals generated during high temperature devolatilization of the solid feedstock 18 (e.g., biomass) by the presence of hydrogen and catalyst, thereby generating stable hydrocarbon molecules that are less prone to, for example, coke formation reactions which may deactivate the catalyst.

The hydroconversion catalyst used in the hydroconversion step includes any suitable hydroconversion catalyst having a desired activity in the temperature range of the disclosed hydroconversion process. For example, the hydroconversion catalyst is selected from sulfided catalysts having one or more metals from the group consisting of Ni, Co, Mo or W supported on a metal oxide. Suitable metal combinations include sulfided NiMo, sulfided CoMo, sulfided NiW, sulfided CoW and sulfided ternary metal systems having any three metals from the family consisting of Ni, Co, Mo and W. Catalysts such as sulfided Mo, sulfided Ni and sulfided W are also suitable for use. The metal oxide supports for the sulfided metal catalysts include, but are not limited to, alumina, silica, titania, ceria, zirconia, as well as binary oxides such as silica-alumina, silica-titania and ceria-zirconia. Preferred supports include alumina, silica and titania. The support may optionally contain regenerated and revitalized fines of spent hydrotreating catalysts (e.g., fines of CoMo on oxidic supports, NiMo on oxidic supports and fines of hydrocracking catalysts containing NiW on a mixture of oxidic carriers and zeolites). Total metal loadings on the catalyst are in the range of from approximately 5 wt % to approximately 35 wt % (expressed as a weight percentage of calcined catalyst in oxidic form, e.g., weight percentage of nickel (as NiO) and molybdenum (as MoO₃) on calcined oxidized NiMo on alumina catalyst). Additional elements such as phosphorous (P) may be incorporated into the catalyst to improve the dispersion of the metal. Metals can be introduced on the support by impregnation or co-mulling or a combination of both techniques. The hydroconversion catalyst used in the hydroconversion step may be, in composition, the same as or different to the deoxygenation catalyst used in the hydropyrolysis step (e.g., first stage 20). In one embodiment of the present disclosure, the hydropyrolysis catalyst includes sulfided CoMo on alumina support and the hydroconversion catalyst includes sulfided NiMo on alumina support.

Following the hydroconversion step, the fully deoxygenated hydrocarbon product 74 is fed to one or more condensers that condenses the hydrocarbon product 74. The condensed hydrocarbon product 74 is fed to a gas-liquid separator 78 to provide a liquid phase product 80 having substantially fully deoxygenated C₄₊ hydrocarbon liquid and aqueous material. The term “substantially fully deoxygenated” is used herein to denote a material in which at least 90 wt % to 99 wt % of the oxygen present in the original lignocellulose containing biomass (e.g., the solid feedstock 18) has been removed. Accordingly, the resulting liquid phase product 80 (e.g., the substantially fully deoxygenated hydrocarbon C₄₊ liquid) contains less than 2 wt %, preferably less than 1 wt %, and most preferably less than 0.1 wt % oxygen. The substantially fully deoxygenated C₄₊ hydrocarbon liquid is compositionally different from bio-oil that is generated using other low pressure hydroprocesses. For example, the oxygen content of bio-oil is greater (e.g., between approximately 5 wt % to 15 wt %) compared to the liquid phase product 80 (e.g., less than 2 wt %). Therefore, due, in part, to the lower oxygen content of the liquid phase product 80, an amount of acid components (as measured by total acid number) and polar compounds is decreased compared to the bio-oil. By way of non-limiting example, the acid components include carboxylic acids, phenols and mixtures thereof.

The hydrocarbon product 74 undergoes a separation process in the gas-liquid separator 78 that separates and removes the aqueous material from the substantially fully deoxygenated C₄₊ hydrocarbon liquid. Any suitable phase separation technique may be used to separate and remove the aqueous material from the substantially fully deoxygenated C₄₋ hydrocarbon liquid, thereby generating the liquid phase product 80 having the substantially fully deoxygenated C₄₊ hydrocarbon and non-condensable gases 82. The non-condensable gases 82 includes mainly H₂, CO, CO₂ and light hydrocarbon gases (typically C₁ to C₃ and may also contain some C₄₊ hydrocarbons).

In certain embodiments, the non-condensable gases 82 are fed to a gas clean-up system 60. The gas clean-up system 86 removes H₂S, NH₃ and trace amounts of organic sulfur-containing compounds, if present, as by-products of the process, thereby generating a hydrocarbon stream 90 having CO, CO₂, H₂ and the light hydrocarbon gases. The gas clean-up system 86 includes one or more process units that remove H₂S 92 and NH₃ 94 from the non-condensable gases 82 as by-products of the process. The hydrocarbon stream 90 may be sent to a separation, reforming and water-gas shift section 98 where the hydrogen 28 is produced from the light hydrocarbon gases in the hydrocarbon stream 90 and renewable CO₂ 100 is discharged as a by-product of the process. A fuel gas stream may be recovered as a by-product of this process. The produced hydrogen 28 may be re-used in the process. For example, the hydrogen 28 may be recycled to the hydropyrolysis reactor 14 in the first stage 20. Sufficient hydrogen is produced for use in the entire process disclosed herein. That is, the quantity of the hydrogen 28 produced by the separation, reforming and water-gas shift section 98 is equal to or greater than the hydrogen required to maintain fluidization and sustain chemical consumption of hydrogen in the process.

The liquid phase product 80 recovered from the gas-liquid separator 78 is fed to a product recovery section 102. In the product recovery section 102, aqueous product 104 is removed from the liquid phase product 80 to generate an intermediate liquid phase product 108. The intermediate liquid phase product 108 may undergo distillation to separate the substantially fully deoxygenated C₄₊ hydrocarbon liquid into fractions according to ranges of the boiling points of the liquid products contained in the intermediate liquid phase product 108. For example, the substantially fully deoxygenated C₄₊ hydrocarbon liquid in the intermediate liquid phase product 108 includes naphtha range hydrocarbons, middle distillate range hydrocarbons (e.g., gas oil, diesel) and vacuum gasoil (VGO) range hydrocarbons.

For the purpose of clarity, “middle distillates” as used herein are hydrocarbons or oxygenated hydrocarbons recovered by distillation between an atmospheric-equivalent initial boiling point (IBP) and a final boiling point (FBP) measured according to standard ASTM distillation methods. ASTM D86 initial boiling point of middle distillates may vary from between approximately 150° C. to approximately 220° C. Final boiling point of middle distillates, according to ASTM D86 distillation, may vary from between approximately 350° C. to approximately 380° C. “Naphtha” as used herein is one or more hydrocarbons or oxygenated hydrocarbons having four or more carbon atoms and having an atmospheric-equivalent final boiling point that is greater than approximately 90° C. but less than approximately 200° C. A small amount of hydrocarbons produced in the process (approximately less than 3 wt % of total C₄₊ hydrocarbons, and preferably less than 1 wt % of total C₄₋ hydrocarbons) boil at temperatures higher than those for the middle distillates as defined above. That is, these hydrocarbons have a boiling range similar to vacuum-gas oil produced by distillation of petroleum. Gasoline is predominantly naphtha-range hydrocarbons and is used in spark-ignition internal combustion engines. In the United States, ASTM D4814 standard establishes the requirements of gasoline for ground vehicles with spark-ignition internal combustion engines. Gas oil (GO)/diesel is predominantly middle-distillate range hydrocarbons and is used in compression-ignition internal combustion engines. In the United States, ASTM D975 standard covers the requirements of several grades of diesel fuel suitable for various types of diesel engines.

Accordingly, in the illustrated embodiment, the intermediate liquid product 108 is fed to a distillation unit 110 to recover gasoline product 112 and a distillate product 114 (e.g., a middle distillate). In certain embodiments, kerosene/jet fuel 116 are recovered as separate streams from the distillation unit 110. The distillate product 114 (e.g., the middle distillate) contains gas oil (GO), for example biodiesel, and is substantially fully free from oxygen, sulfur and nitrogen. In certain embodiments, the oxygen content of the distillate product 114 is less than approximately 1.50 wt %. For example, the oxygen content may be approximately 1.40 wt %, 1.25 wt %, 0.50 wt %, 0.25 wt %, or 0.10 wt % or less. In one embodiment, the sulfur content is less than 100 ppmw. For example, the sulfur content may be approximately 75 ppmw, 50 ppmw, 25 ppmw, 10 ppmw, 5 ppmw, 1 ppmw or less. Accordingly, the biodiesel obtained from the distillate product 114 is considered an ultra-low sulfur diesel (ULSD), which generally has less than 10 ppmw sulfur. Regarding the nitrogen content, in certain embodiments, the nitrogen content of the substantially fully deoxygenated C₄₊ hydrocarbon liquid is less than 1000 ppmw. For example, the nitrogen content may be approximately 750 ppmw, 500 ppmw, 250 ppmw, 100 ppmw, 75 ppmw, 50 ppmw, 25 ppmw, 10 ppmw, or 1 ppmw or less.

As discussed above, hydrocarbon liquid products such as the distillate product 114 generated from hydroprocessing of solid biomass feedstock (e.g., the solid feedstock 18) generally requires additional processing in a third stage to upgrade and improve product properties such as cetane number, reduced density, reduced sulfur and/or nitrogen content, reduced benzene content (e.g., as a result of selective saturation), among others, and facilitate tailoring the overall hydrocarbon product to certain location and market specifications, among other benefits. In certain embodiments, the distillate product 114 may be blended with a hydrotreated ester and/or fatty acid (HEFA) to upgrade and improve properties such as cetane number and density.

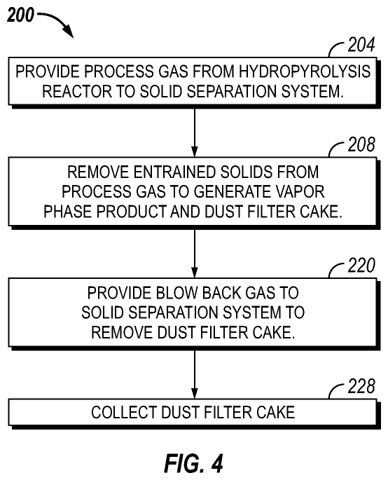

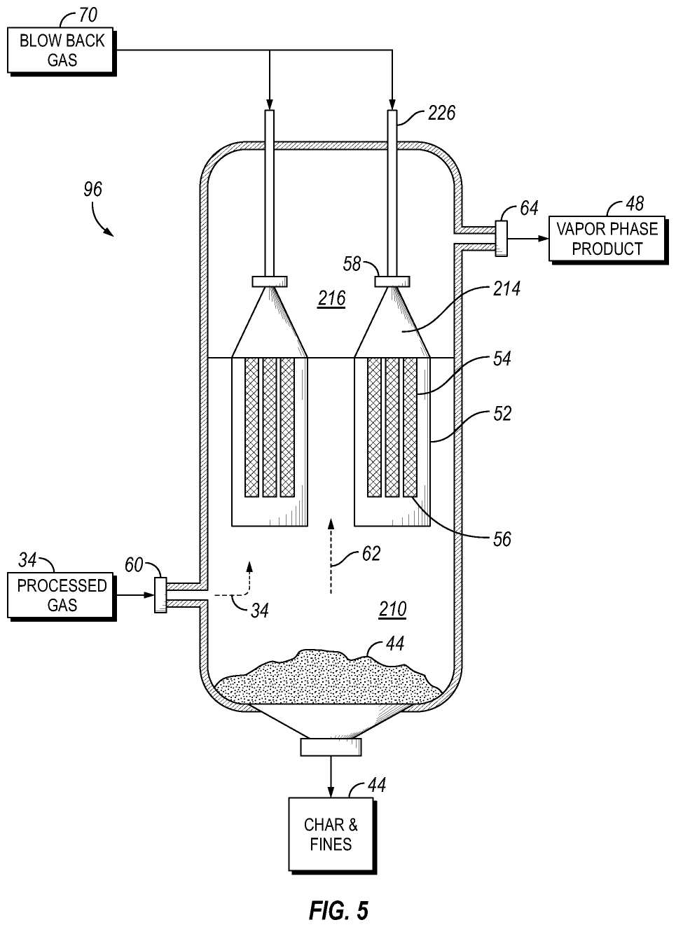

Present embodiments also include a method of removing entrained solids (e.g., the char and fines 44) from a process gas (e.g., the process gas 34) in a solid separation system (e.g., the solid separation system 42). For example, FIG. 4 is a flow diagram of a method 200 that may be used to remove entrained solids (e.g., the char and fines 44) from the process gas using the disclosed hot gas filtration unit (e.g., the hot gas filtration unit 46). To facilitate discussion of the acts of the method 200, reference will be made to FIG. 5. The method 200 includes providing the process gas generated in a hydropyrolysis reactor to the solid separation system (block 204). The method 200 also includes removing the entrained solids from the process gas to generate a vapour phase product (e.g., the vapour phase product 48) and a dust filter cake (block 208). For example, turning to FIG. 5, the hot gas filtration unit 46 receives the process gas 34 through the inlet 60 where it is directed to a space 210. The inlet 60 and space 210 are positioned below the filter elements 52 such that the process gas 34 (e.g., process gas) flows in an upward direction (e.g., the direction 62) toward the filter elements 52. The upward flow of the process gas 34 facilitates separation of dense and heavy particulates that the process gas 34 is unable to carry in the direction 62. The solids/particulates fall toward a solids outlet 210 of the hot gas filtration unit 46 where they are directed to one or more vessels (e.g., the vessel 50) of the solid separation system. However, fine particulates (e.g., catalyst fines, char, and ash) remain entrained in the process gas 34. Therefore, once the process gas 34 reaches the filter elements 52, the remaining entrained particulates are captured on an outer surface of the conduits 54 and the vapour phase product 48 flows through the pores of the conduits 54, into a filtered gas outlet 214 (e.g., a venturi outlet), and into a second space 216, after which the vapour phase product 48 is released from the hot gas filtration unit 42 through the outlet 64. The vapour phase product 48 is substantially free of solids/particulates. For example, the vapour phase product 48 may contain less than approximately 1 mg/Nm³ solids/particulates.

Returning to FIG. 4, the method 200 also includes providing blow back gas (e.g., the blow back gas 70) to the solid separation system and removing the dust filter cake (block 220). As discussed above, the entrained solids/particulates (e.g., catalyst fines, char, and ash 44) in the output (e.g., the process gas 34) are captured on the conduits (e.g., the conduits 54) of filter elements (e.g., the filter elements 52). Therefore, to remove the particulates (e.g., the dust filter cake) accumulated on the conduits, the blow back gas (e.g., the blow back gas 70) is provided to the conduits to blow out and remove the dust filter cake from the outer surface of the conduits. For example, returning to FIG. 5, the blow back gas 70 is injected into gas inlet 226 associated with each respective filter element 52. The gas inlet 226 is fluidly coupled to the filtered gas outlet 214 and the conduits 54. During removal of the dust filter cake from the outer surface of the conduit 54, a flow of the process gas 34 into the hot gas filtration unit 46 is temporarily interrupted. For example, the flow of the process gas 34 is interrupted for between approximately 20 microseconds (ms) to approximately 800 ms. While the flow of the process gas 34 is interrupted, the blow back gas 70 is injected into the gas inlet 226 and exits through the pores of the conduits 54, thereby loosening and removing the dust filter cake from the outer surface.

As discussed above, the process gas 34 includes partially deoxygenated hydropyrolysis product and catalyst fines. The partially deoxygenated hydropyrolysis product may continue to react while in the hot gas filtration unit 46 and form tars and condensates, which plug the pores of the conduit 54. However, by controlling a temperature of the process gas 34 and the blow back gas 70, formation of tars and condensates may be mitigated. For example, the temperature of the process gas 34 and the blow back gas 70 is maintained at a temperature above the condensation temperature of the process gas 34. In certain embodiments, the blow back gas 70 may be preheated to a temperature above the condensation temperature of the process gas 34. For example, the blow back gas 70 may be preheated to a temperature above the condensation (i.e., dewpoint) temperature of the water and/or the hydrocarbons present in the process gas 34. In certain embodiments, the blow back gas 70 may be preheated to a temperature above a de-sublimation temperature of salts (e.g., ammonia chloride (NH₄Cl)) present in the process gas 34. In one embodiment, the filter elements 52 may also be preheated to a temperature above that of the process gas 34 prior to injecting the process gas 34 into the hot gas filtration unit 46 to mitigate the formation of tars and condensates on surfaces of the conduit 54. This may be done by injecting preheated blow back gas 70 or any other suitable particulate-free gas into the conduits 54 and/or into the hot gas filtration unit 46. By way of non-limiting example, the temperature of the process gas 34 and the blow back gas 70 may be between approximately 10 and 30° C. above the condensation temperature of the process gas 34. For example, between approximately 250 and 400° C.

In addition to the temperature of the process gas 34 and the blow back gas 70, formation of tars and condensates, as well as coking, may be mitigated by the frequency at which the blow back gas is provided to the conduits 54 (e.g., how frequently the dust filter cake is removed) and the type of gas used as the blow back gas 70. When using low molecular weight gases (e.g., hydrogen), the amount of blow back gas injected into the conduit 54 may be higher compared to an amount of high molecular weight blow back gases (e.g., carbon dioxide (CO2). While hydrogen is desirable to use as the blow back gas 70 due, in part, to its generation and use in the hydroprocessing process, other blow back gas may be used. For example, the blow back gas may be hydrogen, carbon dioxide, air, or any other suitable gas and combinations thereof. Depending on the composition of the blow back gas 70 used to remove the dust filter cake from the conduits 54, the frequency of the at which the blow back gas is injected into the conduits 54 may vary.

Returning to FIG. 4, following removal of the dust filter cake from the conduit 54 according to the acts of block 220. The method 200 includes collecting particulates from the removed dust filter cake (block 228). As discussed above with reference to FIGS. 2 and 3, the solid separation system 12 includes vessels 50 downstream of the hot filtration unit 46. One or more vessels 50 may receive the particulates 44 removed from the conduits 54 for disposal.

As discussed above, the solid separation system disclosed herein includes a hot gas filtration unit having filter elements that may be used to remove entrained solids/particulates from a process gas generated in a hydropyrolysis processes in an efficient manner without the use of cyclones compared to existing hydroprocessing systems. The disclosed system and methods may also mitigate formation of tars and condensates and coking on outer surfaces of the filter elements, thereby mitigating fouling of the hot gas filtration unit. By replacing cyclones used in existing hydroprocessing systems with hot gas filtration, the removal efficiency of solids of the solid separation system may be improved and the overall cost of the hydroprocessing system and process may decreased compared to existing hydroprocessing systems that use cyclones.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

We claim:

1. A process for producing liquid hydrocarbon products from a solid feedstock comprising:
feeding the solid feedstock and hydrogen to a first stage hydropyrolysis reactor, wherein the first stage hydropyrolysis reactor comprises one or more deoxygenation catalyst, and wherein the solid feedstock comprises biomass, waste plastic, or a combination thereof;
hydropyrolysing the solid feedstock in the first stage hydropyrolysis reactor to generate a process gas stream comprising partially deoxygenated hydropyrolysis product, H₂O, H₂, CO₂, CO, C₁-C₃ gases, and char and catalyst fines; and
feeding the process gas stream to a solid separation system comprising a hot gas filtration unit having a plurality of filter elements configured to separate the char and catalyst fines from the process gas to generate a vapour phase product and a dust filter cake, wherein the vapour phase product comprises the partially deoxygenated hydropyrolysis product, H₂O, H₂, CO₂, CO, and C₁-C₃ gases, and wherein the dust filter cake is disposed on an outer surface of the plurality of filter elements and comprises the char and catalyst fines.

2. The process of claim 1, comprising injecting a blow back gas into a gas inlet fluidly coupled to an outlet of the plurality of filter elements, wherein the blow back gas is configured to remove the dust filter cake from the outer surface of the plurality of filter elements, and wherein the blow back gas comprises the hydrogen, carbon dioxide (CO₂), air, steam or a combination thereof. The process of claim 2, comprising preheating the blow back gas to a temperature above a condensation temperature of the process gas stream or a de-sublimation temperature of salts within the process gas, wherein the condensation temperature of the process gas stream is the condensation temperature of the H₂O, the partially deoxygenated hydropyrolysis product, or the C₁-C₃ gases present is the process gas stream.

4. The process of claim 3, wherein the temperature is between approximately 250° C. and approximately 400° C.

5. The process of claim 2, comprising interrupting a flow of the process gas stream into the hot gas filtration unit before injecting the blow back gas.

6. The process of claim 2, comprising collecting the dust filter cake removed from the outer surface of the plurality of filter elements in one or more vessels disposed within the solid separation system downstream from and fluidly coupled to the hot gas filtration unit.

7. The process of claim 1, comprising preheating the plurality of filter elements to a temperature above a condensation temperature of the process gas stream prior to feeding the process gas stream to the hot gas filtration unit.

8. The process of claim 6, wherein the temperature is between approximately 10° C. and approximately 30° C. above the condensation temperature of the process gas stream.

9. The process of claim 1, wherein the vapour phase product comprises less than approximately 1 milligram (mg)/normal cubic meter (Nm³) weight % solids.

10. The process of claim 1, comprising feeding at least a portion of the process gas stream to a second stage hydroconversion reactor comprising one or more hydroconversion catalyst;
hydroconverting the partially deoxygenated hydropyrolysis product in the vapour phase product to generate a hydrocarbon product comprising substantially fully deoxygenated hydrocarbon product, H₂O, CO, CO₂, and C₁-C₃ gases; and
condensing the hydrocarbon product to generate a deoxygenated hydrocarbon liquid comprising a substantially fully deoxygenated C₄₊ hydrocarbon liquid.

11. A system for producing liquid hydrocarbon products from a solid feedstock comprising;
a hydropyrolysis reactor comprising one or more deoxygenation catalyst and configured to generate a process gas stream comprising partially deoxygenated hydropyrolysis product, H₂O, H₂, CO₂, CO, C₁-C₃ gases, and char and catalyst fines, wherein the solid feedstock comprises biomass, waste plastic, or a combination thereof;
a solid separation system disposed downstream from and fluidly coupled to the hydropyrolysis reactor, wherein the solid separation system is configured to receive the process gas stream and comprises a hot gas filtration unit having a plurality of filter elements configured to remove the char and catalyst fines from the process gas stream to generate a vapour phase product comprising the partially deoxygenated hydropyrolysis product, H₂O, H₂, CO₂, CO, and C₁-C₃ gases; and
a hydroconversion reactor disposed downstream from and fluidly coupled to the solid separation system and comprising one or more hydroconversion catalyst; wherein the hydroconversion reactor is configured to receive the vapour phase product from the solid separation system and to generate a hydrocarbon product from the vapour phase product, wherein the hydrocarbon product comprises substantially fully deoxygenated hydrocarbon product, H₂O, CO, CO₂, and C₁-C₃ gases.

12. The system of claim 11, wherein the hot gas filtration unit comprises a gas inlet extending between a blow back gas source and an outlet of the plurality of filter elements, wherein the gas inlet is configured to inject the blow back gas into an outlet of the plurality of filter elements, and wherein the blow back gas is configured to remove the char and catalyst fines from an outer surface of the plurality of filter elements.

13. The system of claim 11, wherein the blow back gas comprises the hydrogen, carbon dioxide (CO₂), air, nitrogen (N₂), steam, or a combination thereof.

14. The system of claim 11, comprising one or more vessels disposed within the solid separation system downstream from and fluidly coupled to the hot gas filtration unit, wherein the one or more vessels are configured to collect the char and catalyst fines removed from the vapour phase product.

15. The system of claim 11, wherein the vapour phase product comprises less than approximately 1 mg/Nm³ solids.

16. A process for producing liquid hydrocarbon products from a solid feedstock comprising:
hydropyrolysing the solid feedstock in a hydropyrolysis reactor to generate a process gas stream comprising partially deoxygenated hydropyrolysis product, H₂O, H₂, CO₂, CO, C₁-C₃ gases, and char and catalyst fines; and
feeding the process gas stream to a solid separation system disposed downstream from and fluidly coupled to the hydropyrolysis reactor, wherein the solid separation system comprises a hot gas filtration unit having a plurality of filter elements each comprising a conduit having a plurality of pores;
filtering the process gas stream through the respective conduit of the plurality of filter elements to separate the char and catalyst fines from the process gas and to generate a vapour phase product and a dust filter cake, wherein the vapour phase product comprises the partially deoxygenated hydropyrolysis product, H₂O, H₂, CO₂, CO, and C₁-C₃ gases, wherein the dust filter cake is disposed on an outer surface of the respective conduit of the plurality of filter elements, and wherein the dust filter cake comprises the char and catalyst fines.

17. The process of claim 16, comprising injecting a blow back gas into a gas inlet fluidly coupled to an outlet of the plurality of filter elements, wherein the blow back gas is configured to remove the dust filter cake from the outer surface of the conduit, and wherein the blow back gas comprises the hydrogen, carbon dioxide (CO₂), air, steam or a combination thereof.

18. The process of claim 17, comprising preheating the blow back gas, the plurality of filter elements, or both to a temperature above the condensation temperature of the process gas stream.

19. The process of claim 18, wherein the temperature is between approximately 10° C. and approximately 30° C. above the condensation temperature of the blow back gas.

20. The process of claim 18, wherein the temperature is between approximately 350° C. and approximately 400° C.

21. The process of claim 16, wherein the vapour phase product comprises less than approximately 1 mg/Nm³ solids.

22. The process of claim 16, comprising feeding at least a portion of the process gas stream to a second stage hydroconversion reactor comprising one or more hydroconversion catalyst;
hydroconverting the partially deoxygenated hydropyrolysis product in the vapour phase product to generate a hydrocarbon product comprising substantially fully deoxygenated hydrocarbon product, H₂O, CO, CO₂, and C₁-C₃ gases; and
condensing the hydrocarbon product to generate a deoxygenated hydrocarbon liquid comprising a substantially fully deoxygenated C₄₊ hydrocarbon liquid.
